(19) United States
(12) Patent Application Publication
(10) Pub. No.: US 2018/0260799 A1
(43) Pub. Date: Sep. 13, 2018

(54) Smart Shopping Object Detection System

(71) Applicant: Benjamin Doerr, West Bloomfield, MI (US)

(72) Inventor: Benjamin Doerr, West Bloomfield, MI (US)

(21) Appl. No.: 15/456,732

(22) Filed: Mar. 13, 2017

(51) Int. Cl. G06Q 20/20; G06K 7/14; G06K 7/08; H04N 7/18; G06T 7/70

(52) U.S. Cl. CPC G06Q 20/208; G06K 7/1413; G06K 7/1417; H04W 4/008; H04N 7/183; G06T 7/70; G06K 7/087

(57) ABSTRACT

A device added to a shopping cart to streamline and improve the checkout process and timing. The device is used during the process of shopping which is attached or incorporated into the shopping cart consisting of a sensor or many sensors. The shoppers go around the store and add items to the cart. The device uses various sensors camera(s), LiDar, Time of Flight, weight and infrared sensors. The shopper adds the items to the shopping cart. The system detects the items entered and adds them to the purchasing lists. Once the items are collected the shopper takes the shopping cart to the checkout area where the weight of the cart is measured and compared to the total of each individual mass of the items entered into the cart.

### FIELD

The present teachings relate to an optical object recognition sensing device and, more specifically, to a shopping optical object sensing system. Items entered into shopping carts are optically recognized and weighed at the point of sale. This system eliminates the individual scanning of each item.

### BACKGROUND

The current method applies to shopping for many items at the same time such as a weekly grocery list or many items at a retail store. The customer enters the retail area where the customers shops for items to purchase. The items are collected into a shopping cart and the items are brought to a checkout area.

Current checkout areas are where each individual item is handled and scanned by the product bar code. The scanning is generally done either by a person employed by the store or by the customer at a self-checkout lane. At these traditional checkouts each item is rotated or moved until the barcode scanner reads the barcode on the item. The barcode scanners are within the table surface or a hand held apparatus.

The current shopping checkout process time takes several seconds per item to be purchased. The bottleneck is the excessive handling of the items to first unload the item from the shopping cart onto the belt, barcode scan the product, and then load them item into a bag which then gets placed into the shopping cart. The current checkout process is inefficient, cumbersome and causes frustration to the shopping experience.

### SUMMARY OF THE INVENTION

The present teachings related to an apparatus that streamlines the shopping checkout process by detecting each object that is initially entered into the shopping cart by the customer. Once the customer enters the checkout area, the items ready for purchase have already been accounted for in the shopping cart thus reducing the checkout process to merely the payment transaction. The objects for purchase would be detected by various sensors embedded into the shopping cart. The sensor would be able to recognize various sides of the items selected. This apparatus eliminates the needs to unload, scan, bag and reload the shopping cart during the checkout process. The item is handled in the retail store only once until it is ready to be removed after purchase from the shopping cart by the customer for transport to the customer's home. The shopping cart object detection will use 1 or multiple technologies such as but not limited to optical cameras, LiDar, radar and/or sonar.

### BRIEF DESCRIPTION OF THE DRAWINGS

The manner in which the smart shopping object detection system is characteristics can be obtained is explained in the following description and attached drawing in which:

FIG. 1 is a perspective drawing of an application of the object detection smart shopping system attached a shopping cart.

FIG. 2 is a close up perspective drawing of the object detection apparatus.

FIG. 3 is a flow diagram of the object detection system when the customer checkout flow chart.

FIG. 4 is a flow diagram of the object detection system.

### DETAILED DESCRIPTION

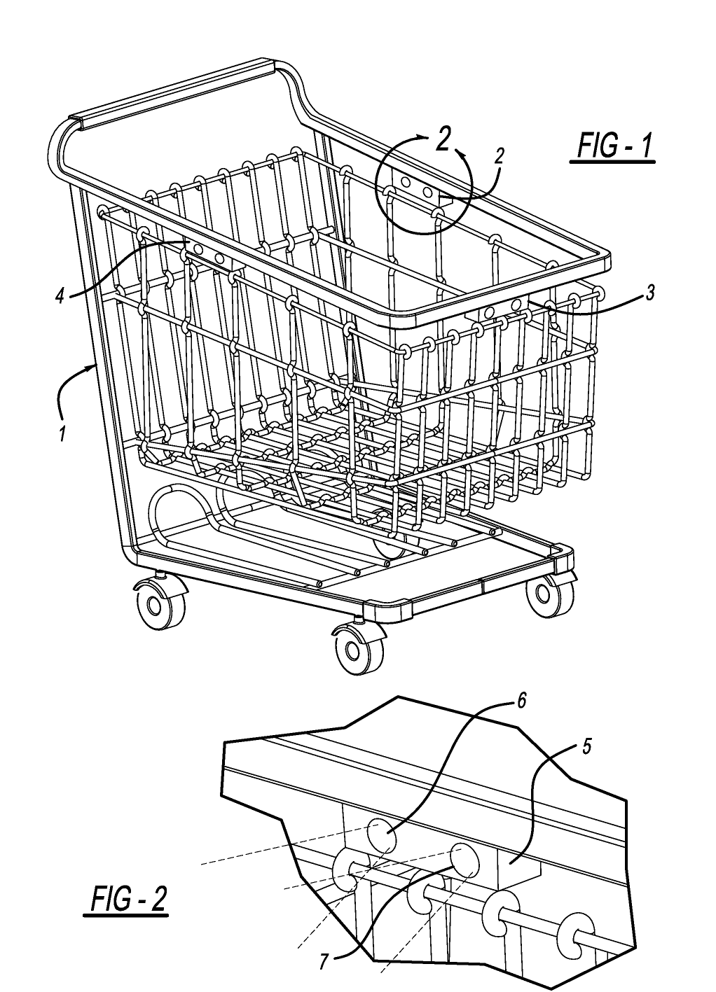

FIG. 1 sets the perspective of the sensor 2, 3 and 4 attached to a shopping basket 1. The sensors 2, 3 or 4 are attached in a way to the basket 1 to have the basket field of view to the items that are inside the basket 1 or entering the basket.

The retail location identifies the customer by using an RFID, magnetic strip reader, Bluetooth or a mobile QR code reader that is embedded into the basket 1 and a corresponding RFID or magnetic strip tag in a card or keychain of shopper or a mobile device. This identification is used to link purchases with the shopper and tally their purchased items.

In FIG. 2. is a closer look of the sensor 2 of the sensor holder 5 with the field of view of the sensor 6 and 7 which is positioned to view inside the basket 1. The sensors include optical cameras, laser, infrared or time of flight cameras. As items enter into a shopping cart associated with a retail location, the shopping cart having a controller (a control module, processing unit); and at least one object detection sensor attached to the shopping cart 1 the sensors 2, 3 and/or 4 identify an item. The controller determines a shopper identification associated with a shopper, identifies purchasable objects from the retail location that are placed into the shopping cart, communicates with a server to determine prices for each of the purchasable objects placed into the shopping cart, determines a total cost of the purchasable objects in the shopping cart, and initiates a transfer of funds corresponding to the total cost of the purchasable objects to an account associated with the retail location.

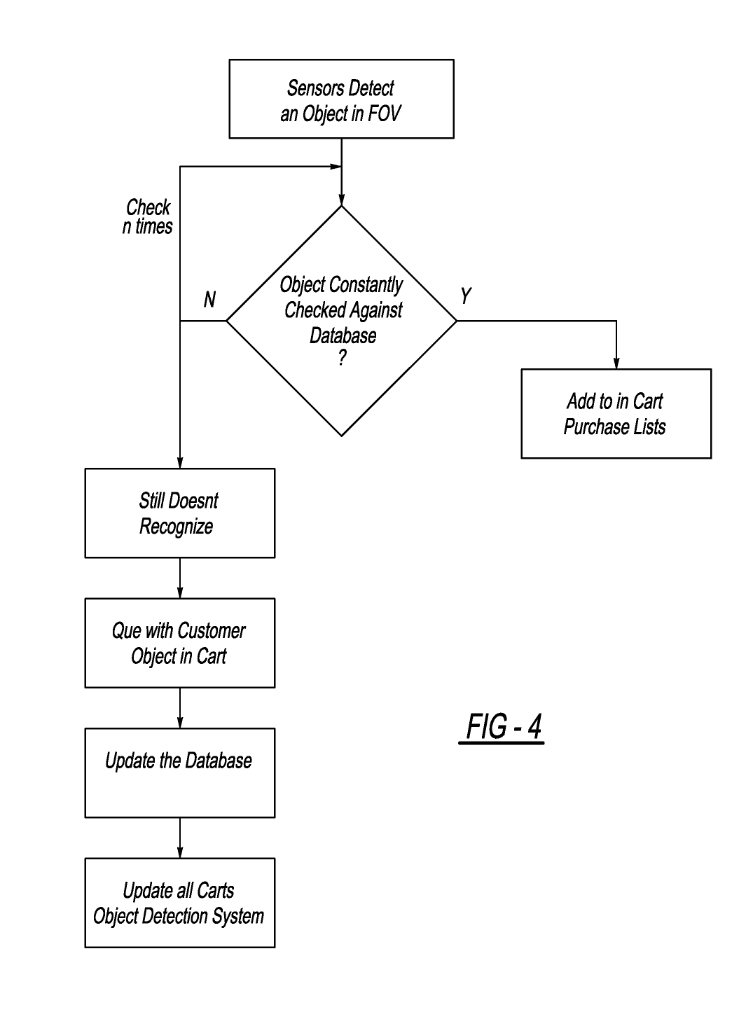

The identification of an object detection is shown in FIG. 4. enters into the field of view of the object's characteristics are checked against the database. If the object is detected and identified with the database the item is added to the lists to be purchased. If the item is not identified it constantly continues to scan within the field of view. If an item is identified to be entered into the basket 1 but not able to be identified against the database after a determined amount of tries will alert the customer. Customer at that time can accurately identify the item that was entered into the cart. Once the item is entered the database is updated with the additional object data points. The rest of the smart shopping cart apparatuses are updated with the additional improved data points.

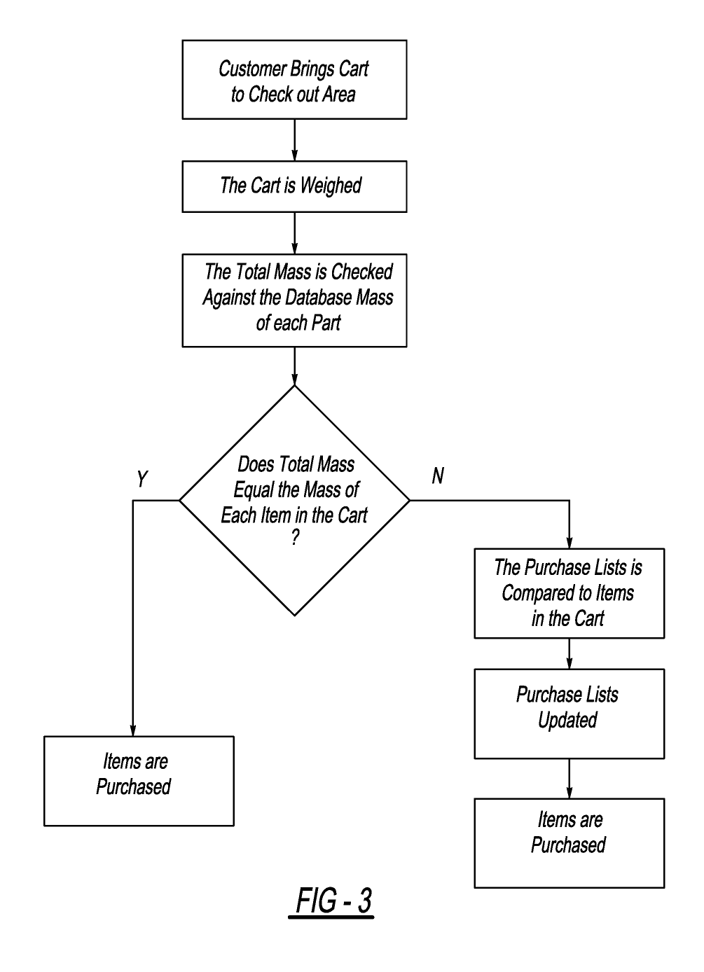

In FIG. 3. once the shopper is finished the shopping cart is taken to the checkout area. The shopping cart is weight and checked against the list of object detected and added to the purchase lists. The shopping cart mass is measured either by built in sensors in the shopping cart 1 or the whole shopping cart is measured on the scale. The mass of the shopping cart is If the mass of the cart 1 is equivalent to the sum of purchase lists from the database of documented masses then then the items can be purchased. If the masses are slightly different the lists from the database is compared to the items within the basket 1 and the additional items or differences in masses are updated. If the database is updated with different masses then the product that has a different mass is updated into all existing smart system.

1. A system comprising:
a shopping cart associated with a retail location, the shopping cart having a controller (a control module, processing unit); and
at least one object detection sensor attached to the shopping cart;
wherein the controller determines a shopper identification associated with a shopper, identifies purchasable objects from the retail location that are placed into the shopping cart, communicates with a server to determine prices for each of the purchasable objects placed into the shopping cart, determines a total cost of the purchasable objects in the shopping cart, and initiates a transfer of funds corresponding to the total cost of the purchasable objects to an account associated with the retail location.

2. The system of claim 1, further comprising an RFID sensor that communicates with an RFID tag of the shopper to determine the shopper identification.

3. The system of claim 2, wherein the RFID tab of the shopper is embedded in a card attached to a keychain of the shopper.

4. The system of claim 1, further comprising a magnetic strip reader that reads an identification of the shopper to determine the shopper identification.

5. The system of claim 1, further comprising a Bluetooth communication system, wherein the controller uses the Bluetooth communication system to communicate with a mobile device of the shopper to determine the shopper identification.

6. The system of claim 1, further comprising an optical reader, wherein the controller uses the optical reader to identify a QR code or barcode associated with the shopper to determine the shopper identification.

7. The system of claim 6, wherein the QR code or barcode is displayed on a mobile device associated with the shopper.

8. The system of claim 1, wherein the at least one object detection sensor includes an optical camera sensor that identifies the purchasable objects based on a shape of the purchasable objects.

9. The system of claim 1, wherein the at least one object detection sensor includes an optical camera sensor that identifies the purchasable objects based on the branding and artwork of the purchasable objects.

10. The system of claim 1, wherein the at least one object detection sensor includes at least one laser sensor that identifies the purchasable objects based shape associated with the purchasable objects.

11. The system of claim 1, wherein the at least one object detection sensor includes at least one infrared sensor that identifies the purchasable objects based on temperature associated with the purchasable objects.

12. The system of claim 1, wherein the at least one object detection sensor includes at least one time of flight camera that identifies the purchasable objects based on distance associated with the purchasable objects.

13. The system of claim 1, wherein the object detection system does not detect the product in the database to prevent fraudulent activities triggers an employee to enter the correct items.

14. The system of claim 13, wherein the object detection system is updated with the correct items. The system then communicates with the server to update the server with new objects that are detected.

15. The system of claim 1, wherein the objects are detected entered into the shopping cart and taken to the the checkout area. The shopping cart is weighed separately on a scale at the checkout area and compared to the total mass of items entered into the cart.

16. The system of claim 1, wherein the objects are detected entered into the shopping cart and weighted using sensors in the shopping cart. The sensors in the shopping cart basket is weighed and compared to the total mass of items entered into the cart.
